(19) United States
(12) Patent Application Publication
(10) Pub. No.: US 2018/0252595 A1
(43) Pub. Date: Sep. 6, 2018

(54) TEMPERATURE SENSOR

(71) Applicant: DENSO CORPORATION, Kariya-city, Aichi-pref. (JP)

(72) Inventors: Motoki SATO, Kariya-city, Aichi-pref. (JP); Takashi HIROSE, Kariya-city, Aichi-pref. (JP)

(21) Appl. No.: 15/758,009

(22) PCT Filed: Sep. 6, 2016
(86) PCT No.: PCT/JP2016/076064

§ 371 Date: Mar. 7, 2018

(30) Foreign Application Priority Data
Sep. 18, 2015 (JP) 2015-185458
Jul. 20, 2016 (JP) 2016-142399

(51) Int. Cl. G01K 7/22

(52) U.S. Cl. CPC G01K 7/22

(57) ABSTRACT

A temperature sensor includes a thermistor element, signal lines 3 and a cover. The thermistor element includes a resistor whose resistance changes with the change of temperature, and electrode wires 22 drawn from the resistor. Each electrode wire 22 and the corresponding signal line 3 are joined to each other, by melting, base materials thereof. The electrode wires 22 contain metallic particles K containing platinum, oxide particles S dispersed in the metallic particles K, and pores H.

### TECHNICAL FIELD

The present invention relates to a temperature sensor for measuring a temperature of a measurement part using a resistor having a resistance that changes with the change of temperature.

### BACKGROUND ART

Electric temperature sensors are known as sensors for measuring temperature of exhaust gas or the like flowing through an exhaust passage of a vehicle. Such an electric temperature sensor uses a thermistor element, a thermocouple, a platinum resistor or the like. A thermistor element or platinum resistor used for a temperature sensor is configured by connecting a pair of electrode wires made of platinum or platinum alloy. For example, in a thermistor type temperature sensor disclosed in Patent Document 1, a pair of electrode wires is made of a dispersion strengthened material obtained by adding a metallic oxide, such as zirconia, to platinum or platinum alloy as a main component. The presence of the metallic oxide prevents grain coarsening of platinum or platinum alloy in the pair of electrode wires.

### CITATION LIST

### Patent Literature

[PTL 1] Japanese Patent No. 3666289

### SUMMARY OF THE INVENTION

### Technical Problem

In Patent Document 1, the temperature sensor is not specifically designed so as to protect a molten joint obtained by melting and joining an electrode wire and a core wire (a signal line) each other. The core wire extracts an output signal from a thermistor element to the outside of the temperature sensor. In Patent Document 1, grain coarsening of platinum or platinum alloy is prevented, thereby preventing disconnecting of the electrode wire. However, the molten joint includes a composition formed of a mixture of platinum or platinum alloy forming the electrode wire and a material forming the core wire. Therefore, there is a need for a design that is unlikely to cause disconnection in an interface between the electrode wire and the molten joint, the disconnection being caused by concentration of thermal stress acting on the interface, and by the difference in linear expansion coefficient between the electrode wire and the molten joint.

The present invention has been made in view of such background and provides a temperature sensor, which is capable of mitigating thermal stress occurring in an electrode wire, and capable of preventing an interface between the electrode wire and a molted joined part from disconnection.

### Solution to Problem

In one embodiment of the present invention, temperature sensor (1) includes a resistor (21), electrode wires (22), signal lines (3) and a cover (4) which covers the resistor and a molten joint (Y) between each electrode wire and the corresponding signal line. The electrode wires includes metallic particles (K) containing platinum, oxide particles (S) dispersed in the metallic particles and pores (H). The resistor has a resistance changing with the change of temperature. The electrode wires are drawn from the resistor. The signal lines are respectively joined to the electrode wires by melting these components.

### Advantageous Effects of the Invention

The temperature sensor includes the dispersion strengthened electrode wire containing the metallic particles and the oxide particles. The electrode wire is formed with pores. When the temperature sensor is used, the periphery of the resistor is placed in an environment where temperature greatly changes, thereby causing thermal stress in the electrode wire. In the electrode wire, the oxide particles are dispersed in the metallic particles. Thus, coarsening of the metallic particles (recrystallization of the metallic particles) at high temperature is prevented, thereby preventing reduction in the strength of the electrode wire.

The electrode wire is formed with pores. The pores are formed by the gases remained when the electrode wire is manufactured by using a sintering method.

When the temperature sensor is used, thermal stress occurring in the electrode wire is mitigated by the pores formed in the electrode wire. Thus, the concentration of thermal stress acting on an interface between the electrode wire and the molten joint is mitigated. Therefore, in the temperature sensor, thermal stress occurring in the electrode wire is mitigated to prevent disconnection of the interface between the electrode wire and the molten joint.

The electrode wire and the signal line are joined by heating and melting the materials configuring them, followed by cooling. In the electrode wire, the presence of the oxide particles prevents recrystallization of the metallic particles, and prevents reduction in the strength of the electrode wire.

### BRIEF DESCRIPTION OF THE DRAWINGS

FIG. 1 is a diagram illustrating a temperature sensor, according to an embodiment.

FIG. 2 is a diagram illustrating a molten joint joining an electrode wire with a signal line and the vicinity thereof, according to the embodiment.

FIG. 3 is a schematic enlarged view illustrating the vicinity of the molten joint joining the electrode wire with the signal line, according to the embodiment.

FIG. 4 is a schematic enlarged view illustrating the vicinity of an interface between the electrode wire and the molten joint, according to the embodiment.

FIG. 5 is a diagram illustrating a molten joint joining an electrode wire with a signal line and the vicinity thereof, according to another embodiment.

FIG. 6 is a diagram illustrating a molten joint joining an electrode wire with a signal line, the molten joint being formed by performing laser irradiation four times, according to the other embodiment.

### DESCRIPTION OF THE EMBODIMENTS

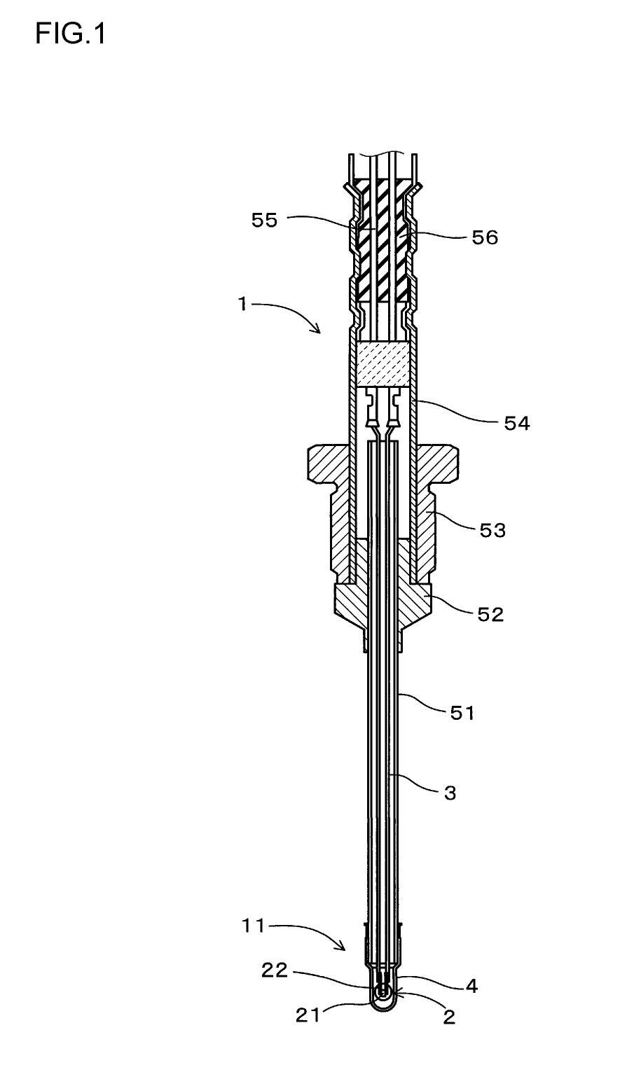

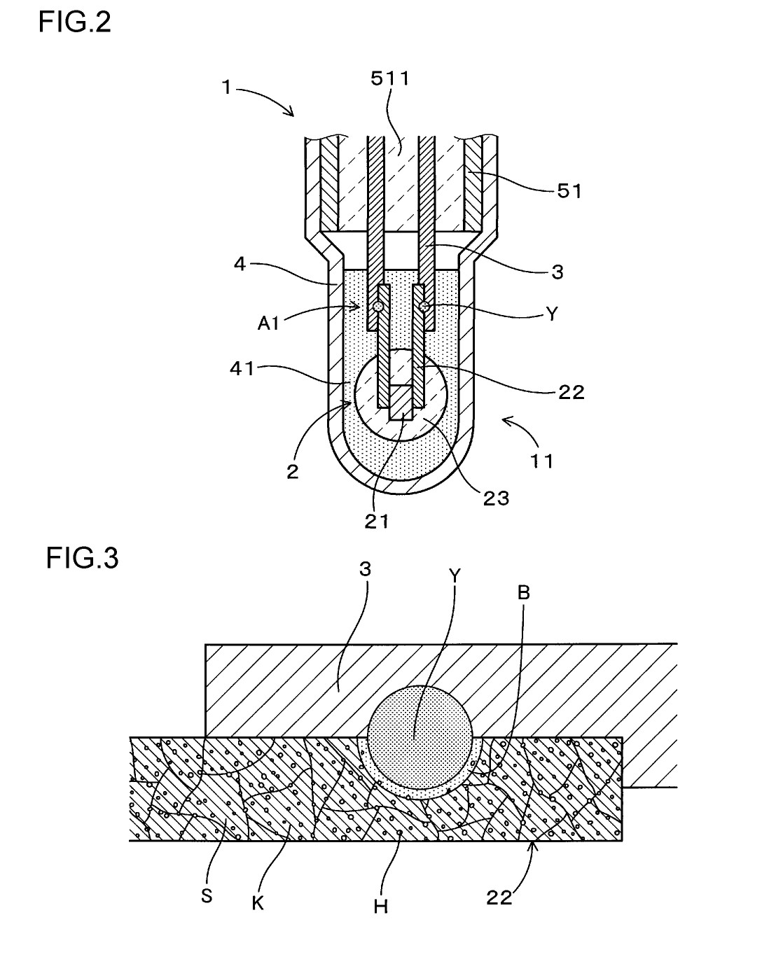

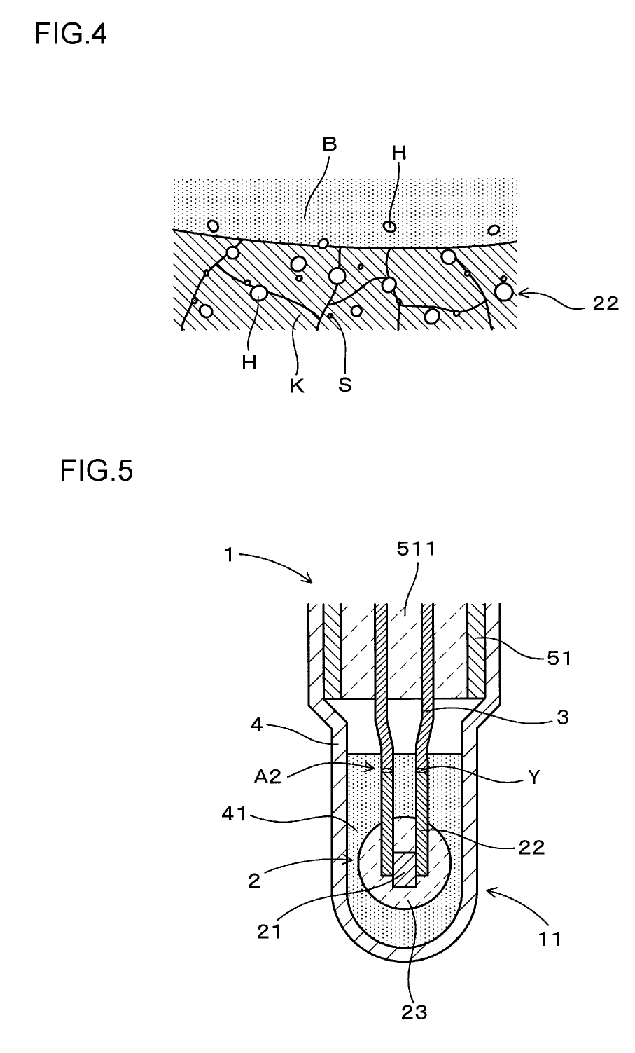

Referring to drawings, preferred embodiments of the temperature sensor set forth above will be described. As shown in FIG. 1, a temperature sensor 1 of the present embodiment includes a thermistor element 2, signal lines 3 and a cover 4. As shown in FIG. 2, the thermistor element 2 includes a resistor 21 whose resistance changes with the change of temperature, and electrode wires 22 drawn from the resistor 21. The electrode wires 22 of the thermistor element 2 and the signal line 3 are joined to each other by melting base materials of these components. The cover 4 covers the thermistor element 2 and a molten joint Y formed by melting and joining the electrode wires 22 and the signal lines 3. As shown in FIGS. 3 and 4, the electrode wires 22 include metallic particles K containing platinum, oxide particles S and pores H. The oxide particles S are dispersed in the metallic particles K.

The temperature sensor 1 of the present embodiment is disposed in an exhaust pipe of an internal combustion engine of a vehicle, and measures temperature of exhaust gas discharged from the internal combustion engine. As shown in FIG. 1, the temperature sensor 1 includes not only the thermistor element 2, the signal lines 3 and the cover 4 but also a tubular member 51, a rib 52, a nipple 53, a protective tube 54, lead wires 55, a bush 56 and the like. The signal lines 3 are inserted into the tubular member 51. The upper side of FIG. 1 is defined as the upper side of the temperature sensor. In the temperature sensor shown in FIG. 1, the upper side is defined as a base end side, and the lower side is defined as a tip end side. The rib 52 of the temperature sensor holds the outer periphery of the tubular member 51 on the base end side. The nipple 53 is connected to the rib 52 to mount the temperature sensor 1 to the exhaust pipe. The protective tube 54 covers the outer periphery of the tubular member 51 on the base end side. The lead wires 55 are connected to the respective signal lines 3. The bush 56 is used for holding the lead wires 55 inside the protective tube 54. The thermistor element 2 is arranged near the tip-end-side end (hereinafter referred to as tip end) of the temperature sensor 1. The thermistor element 2 configures a temperature sensitive portion 11 at the tip end of the temperature sensor 1.

As shown in FIG. 2, the cover 4 is formed in a bottomed cylindrical shape in which the cover 4 is closed on the tip end side. The cover 4 is mounted on the outer periphery of the tip end of the tubular member 51. The cover 4 configures a U-shaped groove therein where a filler 41 is arranged to hold the resistor 21 of the thermistor element 2. The filler 41 is made of insulative ceramic particles or the like. The signal lines 3 are drawn toward the tip end and the base end of the tubular member 51. The signal lines 3 are connected to the respective electrode wires 22. The connection is established between the tip end of the tubular member 51 and the tip end of the temperature sensor 1. The signal lines 3 are connected to the respective lead wires 55. The connection is established between the base end of the tubular member 51 and the base end of the temperature sensor 1. The signal lines 3 are held inside the tubular member 51 by an insulator 511. The signal lines 3 are made of NCF600 or NCF601 that is a superalloy containing Nickel, SUS304 or SUS310 that is a stainless steel, a Fe—Cr—Al alloy or the like.

As shown in FIGS. 1 and 2, the electrode wires 22 in a pair are drawn from the resistor 21 of the thermistor element 2. The pair of the electrode wires 22 are connected to the respective signal lines 3. The pair of signal lines 3 are connected to the respective lead wires 55. The thermistor element 2 has an output signal indicating a change of resistance that occurs at the resistor 21 with the change of temperature. The output signal is extracted to the outside of the temperature sensor 1 by the pair of electrode wires 22, the pair of signal lines 3 and the pair of lead wires 55.

The resistor 21 of the thermistor element 2 is configured by a semiconductor material or the like containing an insulating material. The resistor 21 may be a PTC thermistor, an NTC thermistor or the like. The PTC thermistor has resistance that increases with the rise of temperature. The NTC thermistor has resistance that decreases with the rise of temperature. Materials used for the resistor 21 configuring the PTC thermistor include a ceramic material obtained by adding an additive to barium titanate, and a material formed by dispersing conductive particles, such as carbon black or nickel, in a polymer. Materials used for the resistor 21 configuring the NTC thermistor include a material obtained by mixing and sintering oxides such as of nickel, manganese, cobalt or iron.

Part of the resistor 21 and the electrode wires 22 is covered with a glass layer 23 for reducing oxygen reduction degradation. The metallic particles K in the electrode wires 22 are made of platinum (Pt). A large number of metallic particles K are present in a state of being adhered to each other.

The oxide particles S in the electrode wires 22 are made of zirconia (ZrO₂), that is, particles of a metallic oxide. A large number of oxide particles S are present in the metallic particles K. The amount of the oxide particles S in the electrode wires 22 is 3000 ppm (0.3 mass %) or less relative to the entire electrode wires 22.

The electrode wires 22 are prepared by sintering the powder of the electrode material, followed by performing wire drawing (drawing) of the electrode material. The electrode material contains the metallic particles K and the oxide particles S. Considering wire drawing of the electrode wires 22 containing platinum or the like, the amount of the oxide particles S in the electrode wires 22 is preferably 3000 ppm or less relative to the entirety of the electrode wires 22. When the amount of the oxide particles S in the electrode wires 22 is over 3000 ppm, the hardness of the material of the electrode wires 22 increases excessively, thereby easily causing disconnection in wire drawing.

The particle size of the oxide particles S is 0.5 μm or less. The shape of the oxide particles S is not fixed. The size of an oxide particle S is expressed as the maximum length of the particle. When a line connecting any two points on the outer peripheral surface of an oxide particle S is taken to be a virtual straight line, the length of the largest virtual straight line represents the size of the particle.

As the particle size of the oxide particles S in the electrode wires 22 becomes smaller, dispersion hardening of the wires is more enhanced by the oxide particles S dispersed in the metallic particles K. For reducing recrystallization of the metallic particles K (coarsening of the metallic particles K at high temperature), the particle size of the oxide particles S is preferably 0.5 μm or less, under the conditions where the temperature of exhaust gas measured by the temperature sensor 1 is 1050° C. or less.

FIGS. 3 and 4 schematically illustrate the metallic particles K, the oxide particles S and the pores H for clarity. The illustrated metallic particles K, the oxide particles S and the pores H are not necessarily to scale. The particle size of the oxide particles S is smaller than that of the metallic particles K. The oxide particles S and the pores H are present in the metallic particles K, in between the metallic particles K, and in an interface B between the individual metallic particles K and a molten joint Y. The pores H in the electrode wires 22 are formed by gases or the like remained in the electrode wires 22 when the powder of the electrode wires 22 is sintered.

When the temperature sensor 1 is produced, the thermistor element 2, in which the electrode wires 22 are connected to the respective signal lines 3, is arranged in a U-shaped groove formed with the cover 4. The filler 41 is substantially fully filled in the U-shaped groove. For sintering the filler 41, the tip end including the cover 4 and the thermistor element 2 is heated. During the heating, the electrode wires 22 are heated to a high temperature of 900 to 1100° C. Then, the gases remained in the electrode wires 22 are aggregated, thereby forming the pores H.

The pores H are easily formed in the electrode wires 22 when the filler 41 is sintered. The pores H may be formed in the process other than sintering the filler 41, that is, in the process of heating the electrode wires 22 at high temperature.

As shown in FIG. 2, in the present embodiment, an end of each electrode wire 22 is partially overlapped with a corresponding one of the signal lines 3. The molten joint Y formed on this overlapped part A1 joins the electrode wire 22 to the signal line 3. The electrode wires 22 are respectively joined with the signal lines 3 by laser welding. As another joining method, as shown in FIG. 5, an end face of the electrode wire 22 and that of the corresponding one of the signal lines 3 may be joined by the molten joint Y, thereby forming an abutting part A2.

The molten joint Y is formed, with a material configuring the electrode wires 22 and that of the signal wires 3 each other being melted with each other. In the molten joint Y, melting of the metallic particles K in the electrode wires 22 permits the pores H to almost disappear. However, during laser welding, other pores may be newly formed in the molten joint Y.

The pores H are formed in the electrode wires 22, and in the interface B between each electrode wire and the molten joint Y. The interface B refers specifically to the welded heat-affected portion of each electrode wire 22. The welded heat-affected portion has a crystal grain that is larger than that of the general portion (remaining portion) of the electrode wire 22. The interface B has a pore ratio, that is, pores per unit area (area ratio of the pores H) which is smaller than the pore ratio in the electrode wires 22. The pore ratio in the electrode wire 22 is 4% or less. The pore ratio in the interface B is 3% or less. The pores H are observed in a cut surface obtained by cutting the electrode wire 22. Thus, the number of the pores H is expressed by the pore ratio.

The pore ratio is measured by using an optical microscope or an electron microscope. For example, the interface B is cut such as with ion beam machining. The image of cut surface of the interface B is captured such as by using SEM (scanning electron microscopy), followed by image processing, thereby calculating the pore ratio.

The pore ratio of the interface B refers to a ratio of an area occupied by the pores H relative to the entire area of the cut surface of the interface B. The pore ratio of the electrode wire 22 refers to a ratio of an area occupied by the pores H relative to the area of the cut surface of the electrode wire 22. The gases (air bubbles) in the pores of the interface B are discharged to the outside (atmospheric air) when the electrode wire 22 and the corresponding signal line 3 are weld-bonded to each other. This is because, the metallic particles K in the electrode wire 22 are recrystallized influenced by the welding heat generated during the weld-bonding.

Specifically, recrystallization of the metallic particles K, that is, coarsening of the metallic particles K makes the surface area of the pores H small, thereby removing the pores H. The pore ratio of the interface B is smaller than that of the electrode wire 22. The metallic particles K in the interface B are recrystallized, thereby decreasing the strength of the interface B, and therefore, the welding heat needs not be increased more than necessary.

Laser welding method is preferable as a method of joining the electrode wires 22 with the respective signal lines 3. Laser power for welding is preferably 700 to 800 W.

Welding time is preferably shortened by precisely focusing laser irradiation on a welding part. By shortening welding time, strength reduction of the interface B caused by recrystallization of the metallic particles K in the interface B is not promoted more than necessary. By setting welding time to 2 to 4 msec, the pores in the interface B are decreased, and recrystallization in the interface B is minimized.

When joining an end face of the electrode wire 22 with that of the corresponding one of the signal lines 3 by a single welding process, laser power for welding needs to be increased. In this case, recrystallization in the interface B may be accelerated.

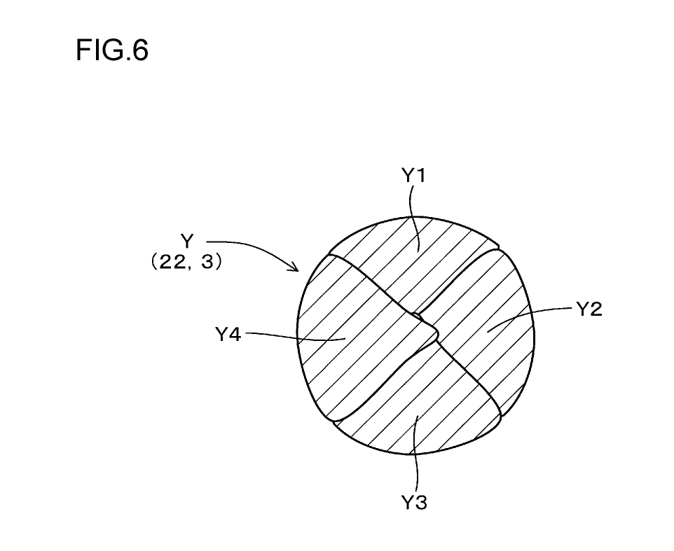

The electrode wires 22 and the respective signal lines 3 may be joined by decreasing laser power for welding and performing welding multiple times. As shown in FIG. 6, for example, an outer periphery of each of joints obtained by butting and joining the electrode wires 22 with the respective signal lines 3 is irradiated with laser four times at every 90° interval in a circumferential direction thereof. This laser irradiation joins the electrode wires 22 with the respective signal lines 3. As shown in FIG. 6, welded parts sequentially formed by performing laser irradiation four times are respectively indicated with Y1, Y2, Y3 and Y4. The molten joint Y is made up of the welded parts Y1, Y2, Y3 and Y4.

Thus, by joining the electrode wires 22 with the respective signal lines 3 as described above, air bubbles in the interface B are discharged externally, and recrystallization of the metallic particles K in the interface B is minimized.

The pore ratio of the interface B refers to a ratio of an area occupied by the pores H relative to the entire area of the cut surface of the interface B. The pore ratio of the electrode wire 22 refers to a ratio of an area occupied by the pores H relative to the area of the cut surface of the electrode wire 22. The gases in the pores of the interface B are discharged to the outside (atmospheric air) while the metallic particles K are melted in the electrode wires 22 at the time of weld-bonding the electrode wires 22 to the signal lines 3. The pore ratio of the interface B is smaller than that of the electrode wire 22.

When the temperature sensor 1 is used, the periphery of the thermistor element 2 is placed in an environment where temperature greatly changes, thereby generating thermal stress in the electrode wires 22. The thermal stress is transferred to the electrode wires 22 from the cover 4 via the filler 41. The thermal stress occurs when the cover 4 is expanded or contracted in response to a cooling and heating cycle of an internal combustion engine. The temperature sensor 1 of the present embodiment is used for measuring exhaust gas of an internal combustion engine of a vehicle, thereby causing stress due to vibration to the electrode wires 22. Thus, it is important to prevent the occurrence of thermal stress and stress due to vibration in the interface B between each electrode wire 22 in the thermistor element 2 and the molten joint Y.

The oxide particles S are dispersed in the metallic particles K in the electrode wires 22. Thus, coarsening of the metallic particles K (recrystallization of the metallic particles K) at high temperature is prevented, thereby preventing reduction in the strength of the electrode wires 22. Formation of the pores H prevents the occurrence of thermal stress and stress due to vibration in the interface B between each electrode wire 22 and the molten joint Y.

This formation of the pores H mitigates thermal stress occurring at the electrode wires 22 when the temperature sensor 1 is used. In addition, the concentration of thermal stress acting on the interface B between each electrode wire 22 and the molten joint Y is mitigated. Specifically, when the electrode wires 22 are heated at high temperature, thermal stress occurring at the electrode wires 22 may be reduced. This is because buffer action is caused by the pores H. Thus, the number of pores H formed in the electrode wires 22 mitigate thermal stress in the entirety of the electrode wires 22. This thermal stress mitigation may be equivalent to that Young's modulus (longitudinal elastic modulus) is reduced in the entirety of the electrode wires 22.

The molten joint Y is formed of a material configuring the electrode wires 22 intermingled with that of the signal wires 3. The material and the linear expansion coefficient of the molten joint Y are different from those of the electrode wires 22. This linear expansion coefficient difference allows the thermal stress to be highest in the interface B between each electrode wire 22 and the corresponding molten joint Y, among the thermal stress generated in the entirety of the electrode wires 22.

The pore ratio of the interface B between each electrode wire 22 and the corresponding molten joint Y is smaller than that of the electrode wires 22. This small pore ratio prevents the interface B having the highest thermal stress from suffering disconnection. Specifically, securing a needed pore ratio, the electrode wires 22 mitigate the thermal stress acting thereon via the cover 4 and the filler 41. Therefore, the thermal stress acting on the interface B via the electrode wires 22 is reduced. The pore ratio of the interface B as a maximum stress loading member is reduced as much as possible to minimize strength reduction of the interface B due to the pores H present in the interface B. Therefore, in the temperature sensor 1 of the present embodiment, the thermal stress generated at the electrode wires 22 is mitigated, thereby preventing disconnection caused in the interface B between each electrode wire 22 and the corresponding molten joint Y.

The vehicle may vibrate during traveling, and the internal combustion engine may vibrate during combustion. These vibrations may be added to the electrode wires 22. Even in such a case, formation of the pores H in the electrode wires 22 mitigates stress acting on the interface B between each electrode wire 22 and the corresponding molten joint Y. Thus, reliability of the temperature sensor 1 in relation to heat and vibration is improved.

Each electrode wire 22 and the corresponding signal line 3 are joined by heating and melting the materials forming them, followed by cooling. Then, solid solution strengthening properties of the electrode wires 22 and the respective signal lines 3 lead to enhancement of the strength of the molten joint Y. Recrystallization of the metallic particles K due to welding heat is not reduced in the interface B. However, in dispersion-strengthened platinum containing the dispersed oxide particles S, coarsening of crystal grain due to recrystallization is not so observed as in platinum-alloy. In this case, platinum-alloy refers to a Pt—Ir alloy, a Pt—Rh alloy or the like containing a solid solution strengthening material, such as Ir or Rh. Specifically, dispersion-strengthened platinum containing the dispersed oxide particles S exhibits higher strength in the welded heat-affected portion than does a solid solution-strengthened platinum-alloy not containing the dispersed oxide particles S. Thus, reliability of the temperature sensor 1 is improved when joining each electrode wire 22 to the corresponding signal line 3.

Accordingly, the temperature sensor 1 of the present embodiment achieves reliability in relation to heat and vibration, and reliability when joining each electrode wire 22 to the corresponding signal line 3.

The metallic particles K used for the electrode wires 22 may also be a platinum-alloy containing at least one of iridium (Ir), rhodium (Rh) and strontium (Sr). In such a case, the wires are dispersion-strengthened, with the oxide particles S being dispersed in the metallic particles K. Solid solution strengthening by using at least one of iridium (Ir), rhodium (Rh) and strontium (Sr) enhances the strength of the electrode wires 22, and reduces recrystallization of the metallic particles K.

That is to say, the electrode wires 22, being coupled with the effect of solid solution strengthening, obtain a strength equal to the dispersion-strengthened platinum even when the content of the oxide particles S is reduced. For example, dispersion-strengthened platinum with an addition of 3000 ppm of oxide particles is referred to as platinum A. A platinum-alloy in which platinum contains 5 mass % of rhodium relative to the entirety of the metallic particles K with addition of 1500 ppm of oxide particles is referred to as platinum-alloy B. The platinum-alloy B has a tensile strength equal to that of the platinum A, but has an extensibility about five times of the platinum A in a 1000° C. atmosphere. Even when rhodium contained in the platinum-alloy B is replaced with iridium or strontium, the effect remains unchanged.

Use of platinum-alloy in the electrode wires 22 improves the elasticity of the electrode wires 22, that is, Young's modulus of the electrode wires 22 is reduced. For example, platinum-alloy used as the electrode wires 22 is dispersed with the oxide particles S and contains at least one of iridium, rhodium and strontium. Use of such a platinum-alloy more effectively reduces thermal stress acting on the interface B between each electrode wire 22 and the corresponding molten joint Y.

To reduce the thermal stress more effectively, each oxide particle S has preferably a 0.5 μm or less particle diameter.

The resistor 21 configuring the thermistor element 2 may be a platinum resistor. The platinum resistor is used for measuring temperature making use of characteristics of platinum, the characteristics being that the resistance changes with the change of temperature.

The present invention should not be construed as being limited to the embodiment described above, but may be embodied in other forms within a range not departing from the spirit of the invention.

### (Confirmation Test)

As a confirmation test, a heat shock test was conducted. In the heat shock test, the temperature sensor 1 having the thermistor element 2 containing the oxide particles S and the pores H was repeatedly applied with thermal shock to examine durability of the electrode wires 22. The temperature sensor 1 was repeatedly applied with ten-thousand cycles of thermal shocks. In one cycle, temperature was changed between room temperature and 1050° C. that was presumed to be exhaust gas temperature in the internal combustion engine. The metallic particles K were platinum particles, and the oxide particles S were zirconia particles. Resistance of the electrode wires 22 was examined by suitably changing the particle diameter of the oxide particles S.

Of the observable oxide particles S in the electrode wires 22, the diameter of the largest oxide particle S was taken to be a maximum particle diameter. The maximum particle diameter of the oxide particle S was examined by using SEM (scanning electron microscopy) at 15000-fold magnification. Durability of the electrode wires 22 resulting from the heat shock test is shown in Table. 1. In the results of durability, O represents the case where no damage was caused, and X represents the case where damage was caused.

TABLE 1

| Maximum particle diameter | Durability |
|---|---|
| of oxide particle | result |
| 0.2 | O |
| 0.5 | O |
| 1.0 | X |
| 2.0 | X |

As shown in the Table, when the maximum particle diameter of the oxide particle S was 0.2 μm and 0.5 μm, the durability results were O, that is, it was confirmed that no damage was caused in the electrode wires 22. When the maximum particle diameter of the oxide particle S was 1.0 μm and 2.0 μm, the durability results were X, that is, it was confirmed that damage was caused in the electrode wires 22.

These results showed that durability of the electrode wires 22 was good, with the maximum particle diameter of the oxide particle S being in the range of 0.2 to 0.5 μm. There are two possible reasons for this as follows. The first reason is that the metallic particles K in the electrode wires 22 were recrystallized at high temperature, and the strength of the electrode wires 22 was reduced, the recrystallization and the reduction being attributed to reduction in the degree of strengthening dispersion due to increase of the maximum particle diameter of the oxide particle S. The second reason is that recrystallization of the metallic particles K in the interface B extremely progressed due to welding heat, and the strength of the electrode wires 22 was reduced, the progress and the reduction also being attributed to reduction in the degree of strengthening dispersion, due to increase of the maximum particle diameter of the oxide particle S.

### REFERENCE SIGNS LIST

1: Temperature sensor

2: Thermistor element

21: Resistor

22: Electrode wire

3: Signal line

4: Cover

Y: Molten joint

K: Metallic particle

S: Oxide particle

H: Pore

1. A temperature sensor comprising:
a resistor having a resistance that changes with the change of temperature;
electrode wires drawn from the resistor;
signal lines joined, by melting, to the respective electrode wires; and
a cover covering the resistor and molten joints in each of which each electrode wire is joined by melting to the corresponding signal line,
wherein the electrode wires contain metallic particles containing platinum, oxide particles dispersed in the metallic particles, and pores.

2. The temperature sensor as set forth in claim 1, wherein,
the pores are formed in the electrode wires and in interfaces each present between each electrode wire and the corresponding molten joint; and
the interfaces each present between each electrode wire and the corresponding molten joint have a pore ratio smaller than that of the electrode wires, the pore ratio representing pores per unit area of the interfaces or the electrode wires.

3. The temperature sensor as set forth in claim 1, wherein the oxide particles have a particle diameter of 0.5 μm or less.

4. The temperature sensor as set forth in claim 1, wherein the electrode wires contain 3000 ppm or less of oxide particles relative to the entire electrode wires.

5. The temperature sensor as set forth in claim 1, wherein the metallic particles are particles of a solid solution obtained by adding at least one of iridium (Jr), rhodium (Rh) and strontium (Sr) to platinum.
